(19) United States
(12) Patent Application Publication
(10) Pub. No.: US 2004/0022055 A1
(43) Pub. Date: Feb. 5, 2004

(54) Push light

(76) Inventor: Perry H. Monitto, Setauket, NY (US)

Correspondence Address: Paul J. Farrell, DILWORTH & BARRESE, LLP, 333 Earle Ovington Blvd., Uniondale, NY, 11553, US

(21) Appl. No.: 10/208,174

(22) Filed: Jul. 30, 2002

(51) Int. Cl. F21L 4/00

(52) U.S. Cl. 362/189

(57) ABSTRACT

A push light having a housing consisting of a housing cover and housing base, an internal illuminating means, four feet members, and a snap switch connected to one of feet having a spring member to resiliently support the housing is provided. The housing may be various shapes and the housing cover may be colored and transparent or translucent to emit soft and beautiful light through the housing cover. The housing base includes four holes to accept four feet, at least one of which has a spring and a shaft. The snap switch is installed on the housing base and on the upper portion of one of feet positioned beneath the housing so that the lamp may be turned on or off when the housing cover is tapped by a user, causing the shaft hit the button of the snap switch and operate the switch.

### BACKGROUND OF THE INVENTION

1. Technical Field

The present invention relates to a push lamp for lighting a certain limited area, and more particularly, to a cube-shaped push light including an internal snap switch in order to conveniently turn on or off the lamp by touching the lamp housing, having at least a foot connected with a button of the snap switch.

2. Background of the Related Art

Lamps are very common and indispensable instruments. Especially, a night lamp is used at a dark site in the home, such as a bedroom, child's room, passageways, or staircases to lighten and prevent a user from accidents when he passes these places. Such lamps usually have a switch to turn on or off. Various types of lamps have been developed. For example, U.S. Pat. No. 3,819,924 to Tomas et al. is directed to an electric lamp which comprises a translucent plastic case having a conical shape, an internal lamp in the case, a lamp socket removably mounted on a spider which is fastened to the bottom of the casing, a pair of annular members fitted over the conical section, and a manual switch.

U.S. Pat. No. 6,250,773 B1 to Lai is directed to a night lamp which comprises essentially a luminescent sheet positioned against snap protrusions provided in a semi-circular arc-like upper shade such that the luminescent sheet can be affected by the arc curvature of said upper shade to form a corresponding semi-circular arc plane and protrude out of an open portion on the upper shade. As the upper shade covers the night lamp body, the luminescent sheet is held between the upper shade and the semi-circular arc-like protruding block of the night lamp body and fits intimately against the protruding body. At the same time, the conductive ends extended on ends of the luminescent sheet contact conductive springs slipped on shaft levers provided on a positioning seat of the night lamp body.

Even though these lamps may be suitable for the specific individual purposes for which they are designed, they differ from the present invention in that the present invention provides several unique features and advantages as hereinafter contrasted.

### SUMMARY OF THE INVENTION

An object of the present invention is to provide a novel type of night lamp for illuminating a dark site, which has a simple configuration, is convenient to use, and is economical to manufacture.

In accordance with the present disclosure, a night lamp having a housing consisting of a housing cover and housing base, an internal illuminating means, four feet members, a snap switch connected to one of feet having a spring member to resiliently support the housing is provided. The housing may be of various shapes and the housing cover may be colored and transparent or translucent to emit soft and beautiful light through the housing cover. The housing base includes four holes to accept the four feet, at least one of which has a spring and a slidable shaft. The snap switch is installed on the housing base and on the upper portion of one of feet positioned beneath the housing so that the lamp may be turned on or off when the housing cover is tapped down by a user, causing the shaft hit the button of the snap switch and operate the switch.

### BRIEF DESCRIPTION OF THE DRAWINGS

The above objects and other advantages of the present invention will become more apparent from the following detailed description taken in conjunction with the accompanying drawings, in which:

FIG. 1 illustrates a perspective view of a cube push light in accordance with a preferred embodiment of the present invention;

FIG. 2 illustrates an exploded perspective view of the inner portion of a housing cover and a housing base;

FIG. 3 illustrates an exploded perspective view of the inner portion of a housing cover and a housing base of an alternate embodiment of the light of FIG. 2;

FIG. 4 illustrates an exploded perspective view of the inner portion of a housing cover and a housing base of a further embodiment of the light of FIG. 2;

FIG. 5 illustrates an exploded perspective view of the inner portion of a housing cover and the bottom of the housing base;

FIG. 6 illustrates a side sectional view showing a preferred embodiment of the foot system in accordance with the present invention; and

FIG. 7 illustrates a side sectional view showing a preferred embodiment of the foot system connected to a snap switch in accordance with the present invention.

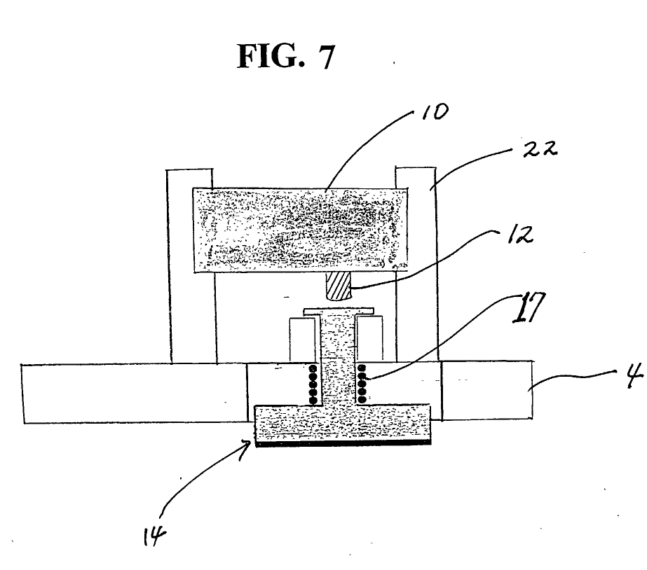

### DETAILED DESCRIPTION OF PREFERRED EMBODIMENTS

Preferred embodiments of the presently disclosed push light will now be described in detail with reference to the drawings in which like reference numerals designate identical or similar elements in each of the several views.

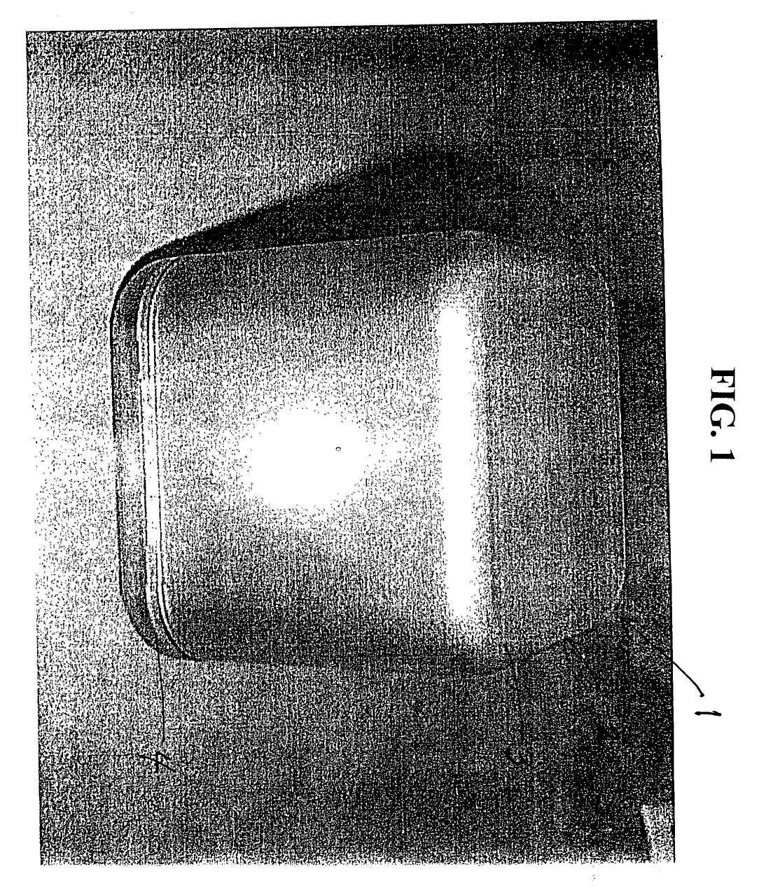

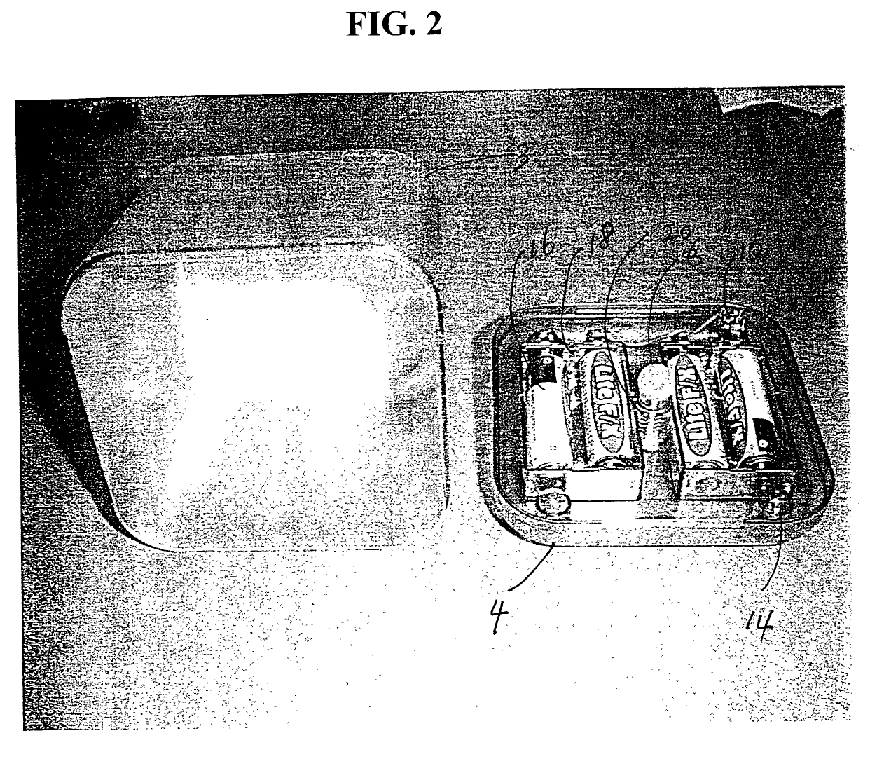

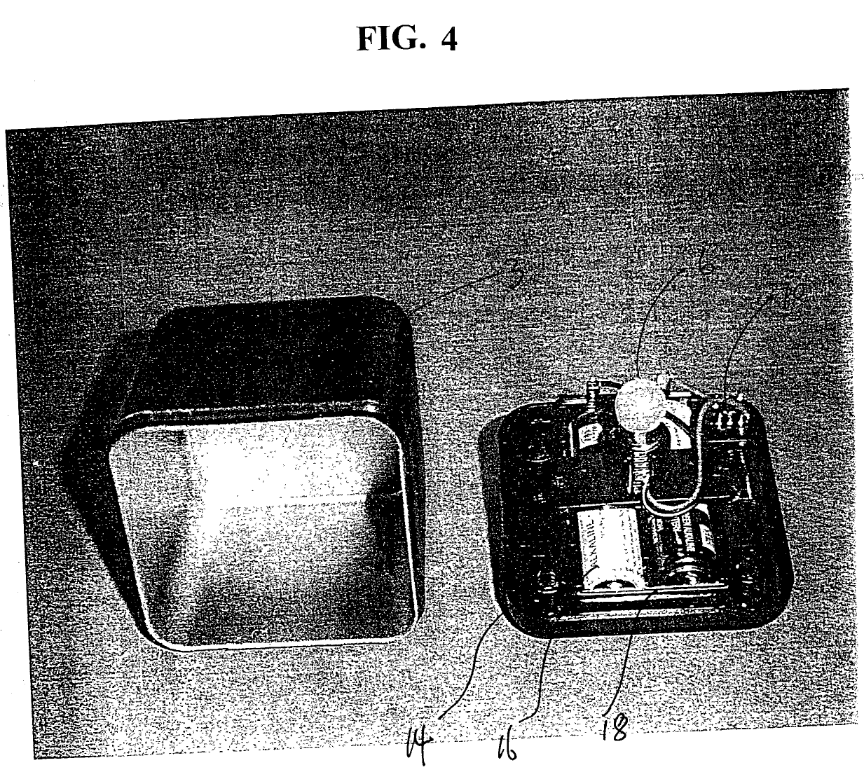

Referring to FIGS. 1-5, a push light 1 comprises a housing 2 consisting of a housing cover 3 and a housing base 4. Housing cover 3 and housing base 4 are combined with each other to form a substantially hollow interior space of the housing 2. The shape of housing 2 may be a hexahedron, globe, pyramid or other types of cubic bodies as long as housing 2 will have a hollow interior space to hold at least one internal illuminating means, such as a bulb 6. Housing cover 3 is preferably made of plastic. Housing cover 3 is transparent or translucent so that the light of the bulb 6 in the housing 2 may be transmitted. Housing cover 3 may also be in any color. Housing base 4 is also preferably made of plastic and supports the housing cover 3 to make a cubic shape having a hollow interior space. Housing base 4 includes at least one hole to accommodate a foot member 8. Preferably, housing base 4 is provided with four holes into which are inserted four foot members 8. Bulb 6 installed in the housing 2 is an electric bulb. At least one battery 16 is provided in the housing 2. Preferably, battery 16 is positioned in a battery housing 18 configured on the housing base 4. Preferably, two battery housings are provided. Bulb 6 is fit into the socket 20 and installed adjacent to the battery housing 18, as shown in FIG. 2, or alternatively as shown in FIG. 4.

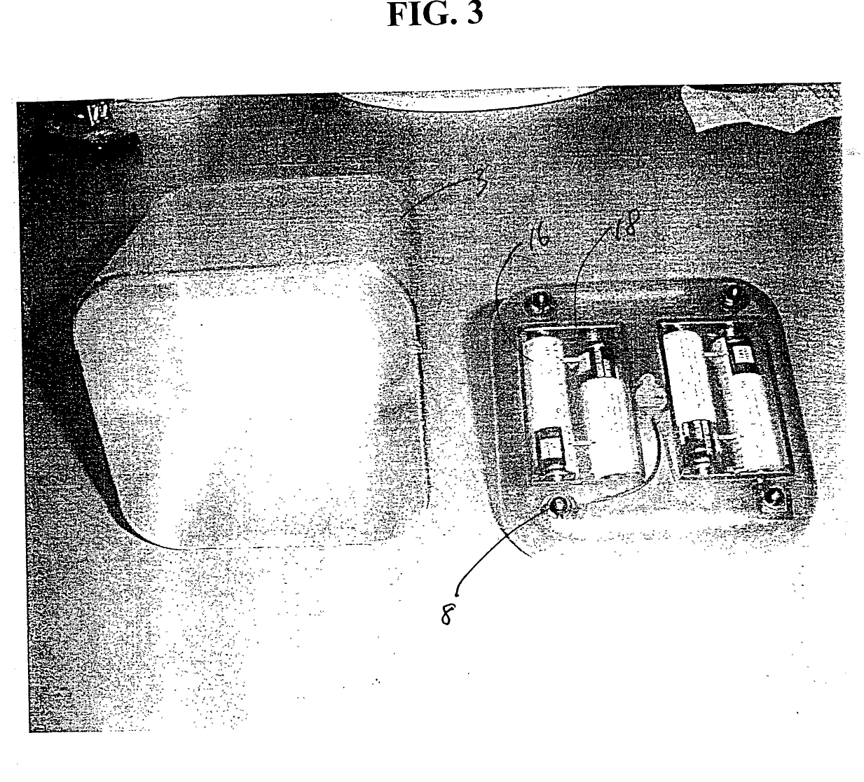

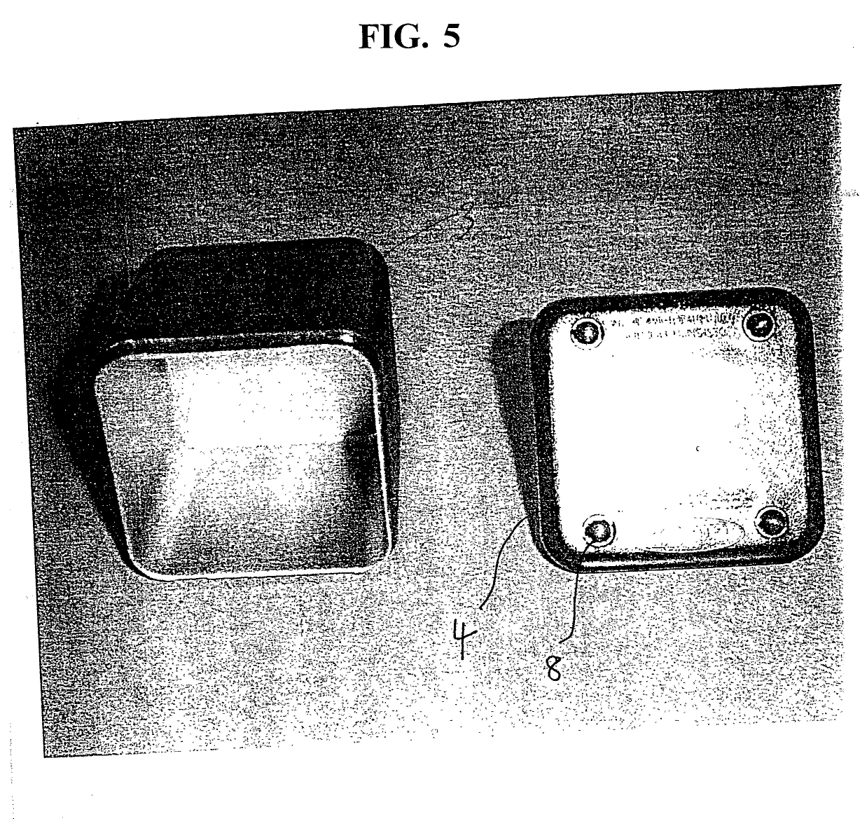

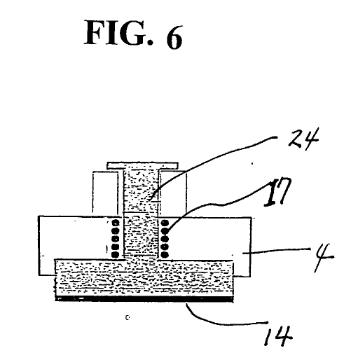

Referring to FIG. 3, 5, 6 and 7, preferably four holes are provided with the housing base 4 into which are inserted four feet members 8 as shown in FIG. 6, and at least one of the foot members comprises a shaft 24, a spring 17, and a rubber pad 14 as shown in FIGS. 3 and 5. The power of the battery 16 is supplied to the bulb 6 via a switch 10 so that the bulb 6 may be lit. Switch 10 is preferably a snap switch that can be placed in an on and off position by pushing a button 12 thereof, and is preferably connected to one of the feet. Button 12 of the switch 10 installed beneath the switch 10 is preferably oriented downwardly and is engaged by the upper portion of the shaft 24 of the feet members 8. Preferably four feet 8 are provided under the housing base 4 and installed through the holes of the housing base 4. Each foot 14 is inserted into one of the holes of the housing base 4 and supports the housing base 4. The elastic power of the spring is preferably higher than that of housing weight gravity and enough to support the housing 2. When a user touches downwardly the housing cover 3 and the housing 2 moves down, the shaft 24 of the foot 8 pushes the button 12 of the switch 10 and the switch 10 moves to the on position to turn on the lamp. When the user touches the housing cover 3 again and the housing 2 moves down, the shaft 24 of the foot 8 pushes the button 12 of the switch 10 and the switch 10 is moved to the off position to turn off the lamp.

It will be understood that various modifications may be made to the embodiments disclosed herein. Therefore, the above description should not be construed as limiting, but merely as exemplifications within the scope and spirit of the claims appended hereto.

What is claimed is:

1. A push light comprising:
a housing consisting of a housing cover and a housing base combined with each other to form a substantially hollow interior space;
an internal light installed in the hollow interior space of the housing;
at least one foot member including a compressing spring to support the housing;
a switch engagable with the foot member in order to turn on or off the light by pushing the housing.

2. The light according to claim 1, further comprising at least one battery to provide power to the light.

3. The light according to claim 1, wherein the housing cover is one of transparent and translucent.

4. The light according to claim 1, wherein the housing is made of plastic material.

5. The light according to claim 1, wherein the housing is cube-shaped, pyramid-shaped, or globe-shaped.

6. The light according to claim 1, wherein the switch is a snap switch.
